(19) United States
(12) Patent Application Publication
(10) Pub. No.: US 2016/0358291 A1
(43) Pub. Date: Dec. 8, 2016

(54) COMPUTERIZED BACK SURGERY PREDICTION SYSTEM AND METHOD

(71) Applicant: Humana Inc., Louisville, KY (US)

(72) Inventors: Sandy Chiu, Louisville, KY (US); Vipin Gopal, Louisville, KY (US)

(73) Assignee: Humana Inc., Louisville, KY (US)

(21) Appl. No.: 14/152,542

(22) Filed: Jan. 10, 2014

Related U.S. Application Data
(60) Provisional application No. 61/751,066, filed on Jan. 10, 2013.

(51) Int. Cl. G06Q 50/22; G06Q 10/06

(52) U.S. Cl. CPC G06Q 50/22; G06Q 10/0635

(57) ABSTRACT

A computerized back surgery predictive model identifies a risk population for back surgery and assigns a severity level to members of the risk population. High risk members are informed of preference-sensitive surgeries and alternative treatment options. The model focuses on members of the population with back condition related claims and is trained using data for members with primary diagnoses associated with various types of visits, procedures, and treatments for back pain. In an example embodiment, the model is applied to member populations to predict a first back surgery (e.g., spinal fusion, kyphosplasty, vertebroplasty, or decompression surgery) within one year after identified triggers. Predictors are historical risk factors from a broad set of data sources. Members are scored monthly to allow for continuous monitoring of the changing risk of back surgery and to allow timely intervention. The model may be tailored for different populations such as commercial and Medicare populations.

### CROSS-REFERENCE TO RELATED APPLICATIONS

This application claims priority to U.S. Provisional Patent Application Ser. No. 61/751,066, filed Jan. 10, 2013 and titled BACK SURGERY PREDICTIVE MODEL, the contents of which is incorporated herein by reference.

### BACKGROUND

Back pain affects eight out of 10 people during their lifetimes. Low back pain is the fifth most common reason for doctor's office visits while one in four adults report having it last at least a day. In 2008, about 3.4 million emergency department visits and 663,000 inpatient stays at US hospitals were specifically for back problems or treatments.

Americans spend at least $50 billion each year on low back pain procedures and treatments. Back pain is the most common cause of job-related disability and a leading contributor to missed work. Annually, low back pain is estimated to account for more than $26 billion in direct health care costs in the US. Overall costs in 2008 for inpatient stays for back problems was over $9.5 billion, the ninth most expensive condition treated in US hospitals.

Back surgeries are expensive procedures. The number of complex and invasive surgeries is increasing. From 2002 to 2007, the rate of decompressions and simple fusions had decreased, but complex fusions increased 15-fold. Failed back surgery syndrome can occur in as many as 10% -40% of lumbar spine surgery patients. Often alternative treatment options are available and could be more effective than preference-sensitive procedures, if at-risk patients are educated and directed to an early intervention. The best outcomes of reduced cost and fast recovery are the results of informed and shared decision making between the physician and the patient.

Although patients would benefit from early intervention, there is no automated system for identifying patients that may be at-risk for a back surgery and for notifying a physician or other healthcare provider that a patient may be at-risk for a serious back condition. Patients as well as health care providers and payers can all benefit from such a system because it would reduce expenditure for back treatments and surgeries and lead to better outcomes and lifestyles for patients. There is a need for an automated back surgery prediction system and method that can identify the surgery risk (probability of a surgery) for each patient and further direct the patient to an intervention that may obviate the need for surgery.

### SUMMARY

The present disclosure is directed to a computerized back surgery predictive model for identifying a risk population for back surgery and assigning a severity level to members of the risk population. High risk members are informed of preference-sensitive surgeries and alternative treatment options. The identification of a risk population allows a health benefits provider to maximize early intervention opportunities with informed clinical decision support.

The model is designed to focus on members of the population with back condition related claims. The model is trained using data for members with primary diagnoses associated with various types of visits, procedures, and treatments for back pain. In an example embodiment, the model is applied to member populations to predict a first back surgery within one year after identified triggers. Surgeries include spinal fusion, kyphosplasty, vertebroplasty, and decompression surgeries.

In an example embodiment, predictors are historical risk factors from medical and prescription claims in the past 12 months, including both paid and encounter claims. Members are scored monthly to allow for continuous monitoring of the changing risk of back surgery and to allow timely intervention. The model may be tailored for different populations such as commercial and Medicare populations.

### BRIEF DESCRIPTION OF THE DRAWINGS

FIG. 1 is a back surgery predictive model framework according to an example embodiment;

FIG. 2 is an illustration of monthly scoring according to an example embodiment;

FIG. 3 is a block diagram illustrating seasonality features according to an example embodiment;

FIG. 4 is a graph of actual days to surgery for a Medicare population;

FIG. 5 is a graph of actual days to surgery for a commercial population;

FIG. 6 is an illustration of top predictors for a Medicare population according to an example embodiment; and

FIG. 7 is an illustration of top predictors for a commercial population according to an example embodiment.

### DETAILED DESCRIPTION

The disclosed computerized back surgery predictive models identify members of different healthcare populations (e.g., Medicare and commercial) who are at risk of major back surgeries such as spinal fusion, kyphosplasty, vertebroplasty and decompression in a defined period (e.g., next 12 months). The higher the score, the higher the likelihood that a member will have a major back surgery during the period. Medicare and commercial populations are scored by different models as these two populations have very different demographics and healthcare utilization patterns.

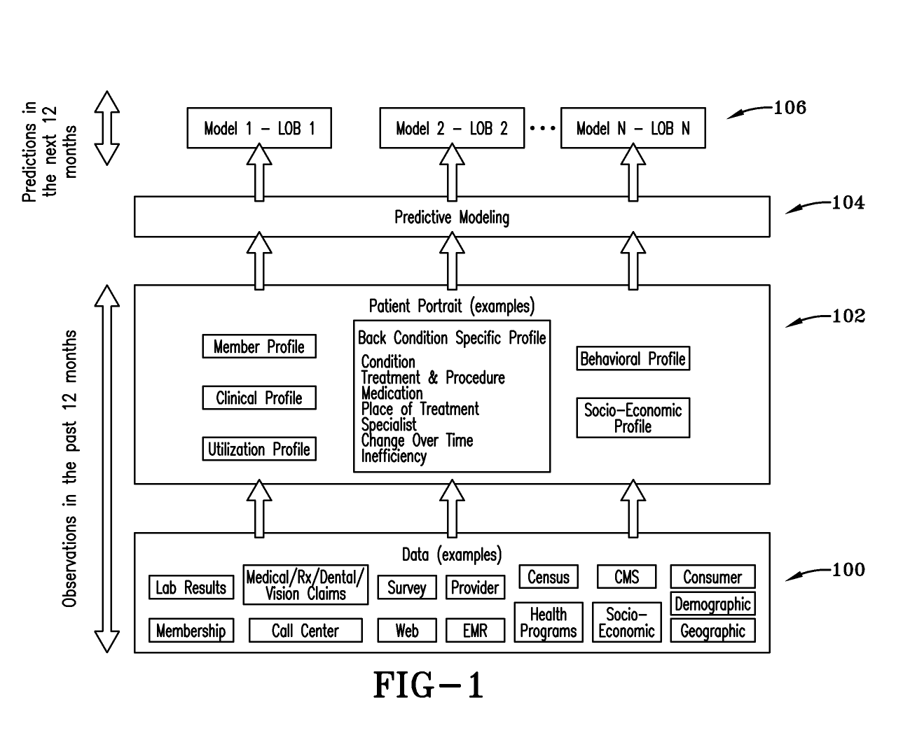

Referring to FIG. 1, a back surgery predictive model framework according to an example embodiment is shown. The example model framework comprises four primary components. The first component is a set of data sources 100 that may include laboratory result and biometric data, membership data, health claims data (e.g., medical, prescription, dental, and vision claims), health benefit provider call center data, health risk assessment, survey, web and web log data, healthcare provider and electronic medical record data (e.g., physician notes), census data, health plan benefit and health program data, Medicare and other socio-economic data, and consumer, demographic and geographic data (e.g., consumer segmentation data).

The model framework further comprises a patient portrait component 102 that further comprises sub-profiles for member, clinical, utilization, behavioral, socio-economic, and back condition specific (e.g., condition, treatment and procedure, medication, place of treatment, specialist, change over time, and inefficiency) data.

In a predictive modeling component 104, data from various data sources 100 is used to create patient portraits 102. Data from the patient portraits are preprocessed, transformed, and prepared for model building using various well known data preparation techniques. The techniques include, but are not limited to, variable selection, principle component analysis, and clustering, etc. Multiple well-known predictive modeling techniques like logistic regression, least angle regression, decision tree, and artificial neural networks are then used to train, validate, and test the model. A model with the best performance indicator, such as ROC and accuracy, is then selected as the winning model to score future at risk members.

Different models 106 may be customized and deployed for different lines of business depending on characteristics of member populations such as demographics and healthcare utilization patterns. Example lines of business may include Medicare, commercial, fully insured, administrative services only, and Medicaid. In an example embodiment, the ROC index for the commercial model based on the test data set is 0.797, and the ROC index for the Medicare model is 0.741. The score represents the probability of a major back surgery in the next 12 months. From the test data, higher percentages of members in the high score groups had at least one back surgery within one year after the score date.

Each model scores the members of the population who have one or more back-related medical conditions. These members have relevant diagnoses, visits, medical treatments, and procedures in claims and/or encounters in prior months (triggers) and therefore, are selected for scoring. The at-risk members are scored monthly to continuously monitor their changing risk for back surgeries and to allow for timely interventions.

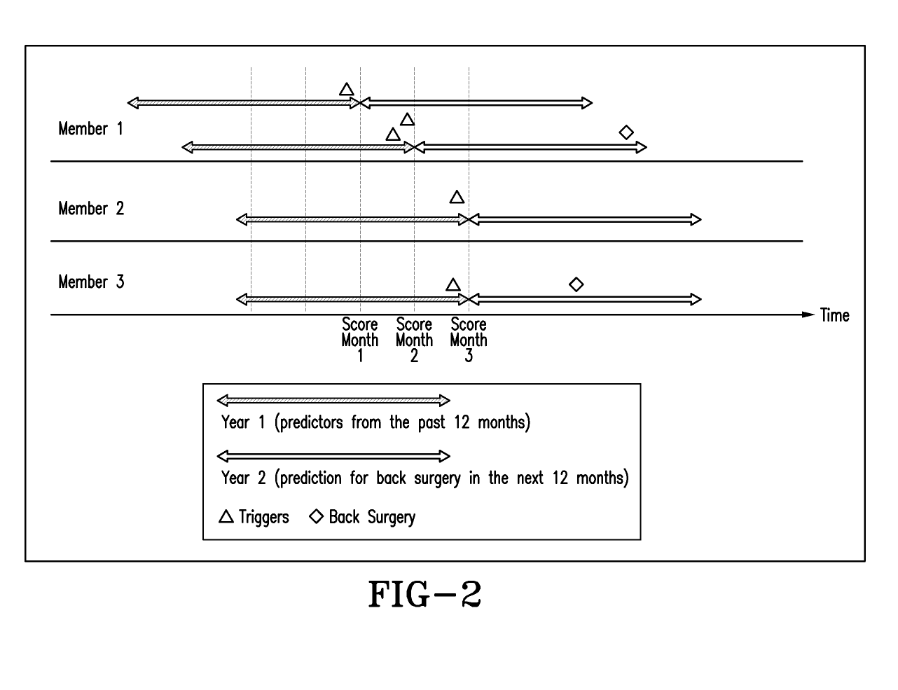

Referring to FIG. 2, an illustration of monthly scoring according to an example embodiment is shown. In an example embodiment, the model uses the historical medical and prescription claims/encounters in the past 12 months to extract health risk factors/predictors and to generate each member's healthcare portrait. Health risk factors and predictors are also extracted from separate periods in the past 12 months in order to detect the changes of members' health and clinical profiles. As shown in Table 1, the healthcare portrait includes five categories: a member profile, an overall clinical and utilization profile, a back condition specific profile, a temporal profile, and an efficiency profile.

TABLE 1
Predictors Considered and Selected from Patient Portrait

| | Predictors |
|---|---|
| Member Profile | Age |
| | Gender |
| | Market |
| | Product |
| | Location |
| | Income |
| | Education |
| Overall Clinical Utilization and | Co-morbidity |
| Prescription Profile | Claims Cost/Count |
| | Place of Treatment |
| | Medications |
| | Pharmacies |
| | Prescribing Physicians |
| Temporal Profile | Velocity |
| | Claims/Utilization Pattern |
| | Change Over Time |
| Back Specific Conditions Profile | |
| Back Specific Conditions | Low Back Pain |
| | Spinal Stenosis |
| | Sciatica |
| | Spondylosis |
| | Neuritis/Radiculitis |
| | Deformity |
| | Fracture |
| | Osteoporosis |
| | Falls |
| | Mental Disorders |
| Back Specific Medications | NSAIDS |
| | Narcotics |
| | Cox 2's |
| | Analgesics |
| | Benzodiazepines |
| | Antidepressants |
| | Anticonvulsants |
| | Muscle Relaxants |
| | Epidural/Steriods/Anesthetics Injections |
| Back Specific Treatments and | Therapies |
| Procedures | Radiology |
| | Surgeries |
| | Implants |
| | Devices |
| | Injections |
| Visits for Back Conditions | Inpatient |
| | Emergency Room |
| | Office Visits/Repeat Office Visits |
| | Inpatient admit via emergency room |
| Back Pain Specialists | Osteopathic |
| | Chiropractic |
| | Acupuncture |
| | Psychiatrist |
| | Rehabilation |
| Inefficiency | Over/under utilization |
| | Over/under medication |
| | Uncoordinated/unauthorized procedure |
| | Uncoordinated/unauthorized medication |

In an example embodiment, pathology and seasonality are taken into consideration. At-risk members are identified by evidence from different pathological stages, level of severity, and time of the year. At-risk members of various pathology and severity levels are including in model training data set, such initial office visits for back pain, hospital stays/ER visits for back conditions, specialists, imaging, pain medication, pain device implant, minor and major back surgeries. Together with the variables of gaps in care, treatment efficiency, overall health condition and comorbidity, at-risk members' back conditions progress at different rates and patterns.

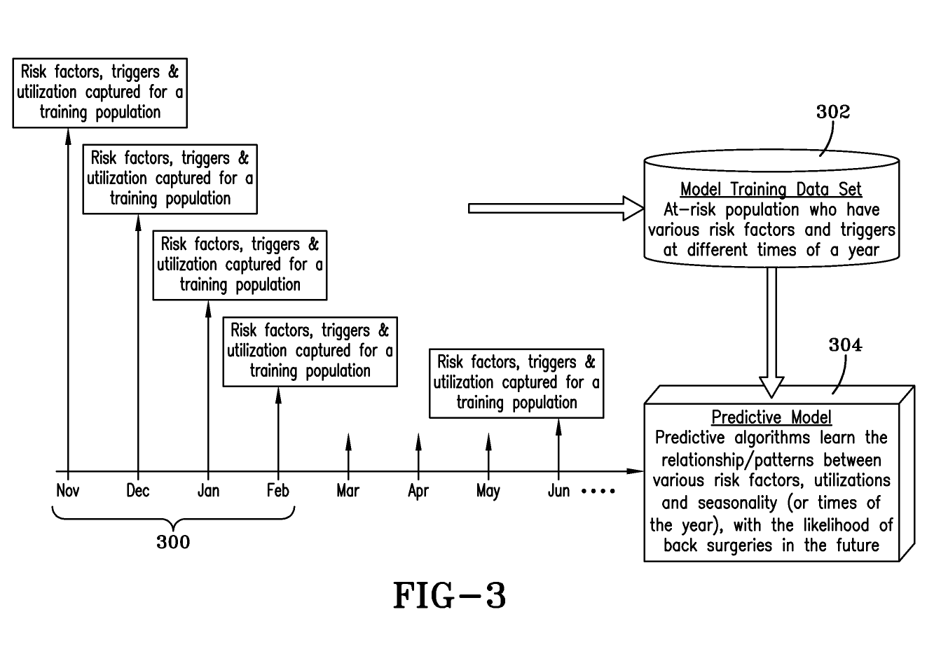

In model development, training samples are also extracted and scored at different times of the year, as various risk factors are related to seasonality. For example, patients' general health conditions, back conditions and utilization patterns may vary with different seasons and months. Referring to FIG. 3, a block diagram illustrating seasonality features according to an example embodiment is shown. In winter months 300, there are generally more cases of back pain, musculoskeletal problems, elderly falls, depressions, respiratory diseases and hospital admissions. The use of seasonality data 302 for model training 304 results in a model that more accurately reflects actual member experiences and risks. Within the same range of scores, the scored members may have a surgery in different points of time within the next 12 months, some are sooner and some are later. This characteristic is similar for various score ranges.

The score range or score threshold used to identify at-risk members may depend on the desired member volume for outreach and intervention. Scored members may be stratified into different buckets (e.g. high, medium, and low). Different ranges of scores provide different intervention opportunities. The score threshold for each bucket also depends on the member volume desired for specific intervention strategy and outreach. The intervention strategies also consider score changes over time (e.g., high or score increase significantly in a certain period of time).

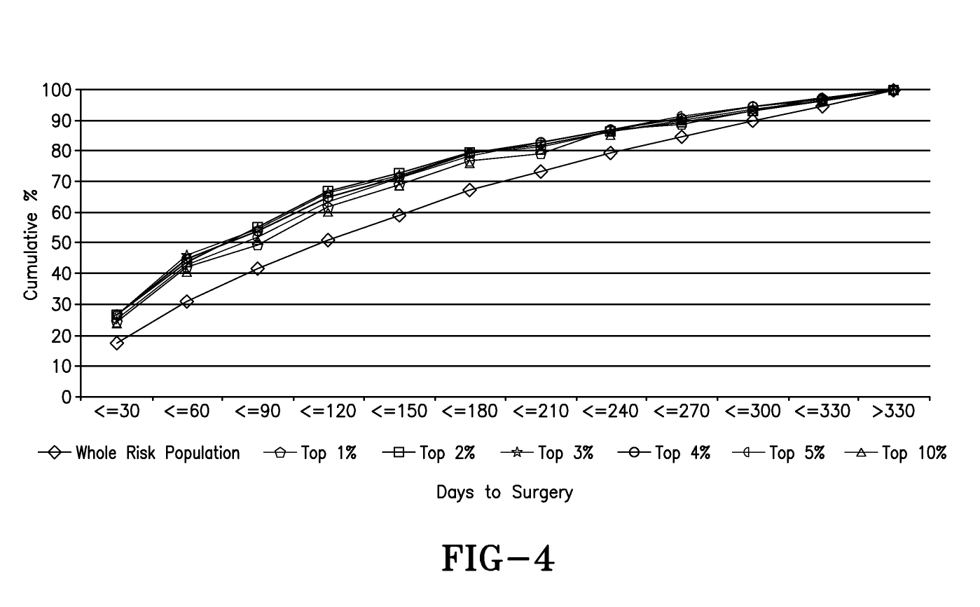

Referring to FIG. 4, a graph of actual days to surgery for a Medicare population is shown. Actual days to surgery are shown for the Medicare population that scored in the top 1%, top 2%, top 3%, top 4%, top 5% and top 10% groups. Surgery rate for the overall Medicare at risk population vs. that of the population with high predicted scores are shown in Table 2.

TABLE 2
Medicare Days to Surgery

| | % Expected to have back surgeries | Improvement |
|---|---|---|
| Population | within one year after score date | Rates |
| Whole risk population | 5.17% | |
| Top 1% | 26% | 5.03 |
| Top 2% | 24.13% | 4.67 |
| Top 3% | 21.09% | 4.08 |
| Top 4% | 19.69% | 3.81 |
| Top 5% | 19.30% | 3.73 |
| Top 10% | 16.63% | 3.22 |

Top 5% of the scored Medicare members have significantly high values in a number of risk measures such as overall cost, hospital days, pain management, physical therapy, radiology, implanted pain device, but lower value in preventive measure such as Acupuncture/Chiropractic Osteopathic utilization.

TABLE 3
Risk Measures of the Top 5% Scored Medicare Members

| | Identified Members | Top 5% |
|---|---|---|
| | Annual Average | Annual Average |
| Measures | (Per Member) | (Per Member) |
| Allowed Amount | $11,143,32 | $18,710.07 |
| Hospital Days | 2.80 | 4.13 |
| Pain Management Injection/ | $265.20 | $816.19 |
| Procedure Cost | | |
| Acupuncture/Chiropractic/ | $26.25 | $21.55 |
| Osteopathic Cost | | |
| Physical Therapy Cost | $598.89 | $1,026.71 |
| Radiology Cost | $322.73 | $1,026.71 |
| Implant Pain Device Cost | $584.64 | $1,791.76 |
| Facet Injection Cost | $64.12 | $120.43 |
| Spinal Fusion Cost | $882.55 | $3,407.27 |
| Kyphosplasty/Vertebroplasty | $74.58 | $402.48 |
| Cost | | |
| Decompression Cost | $777.63 | $3,004.84 |

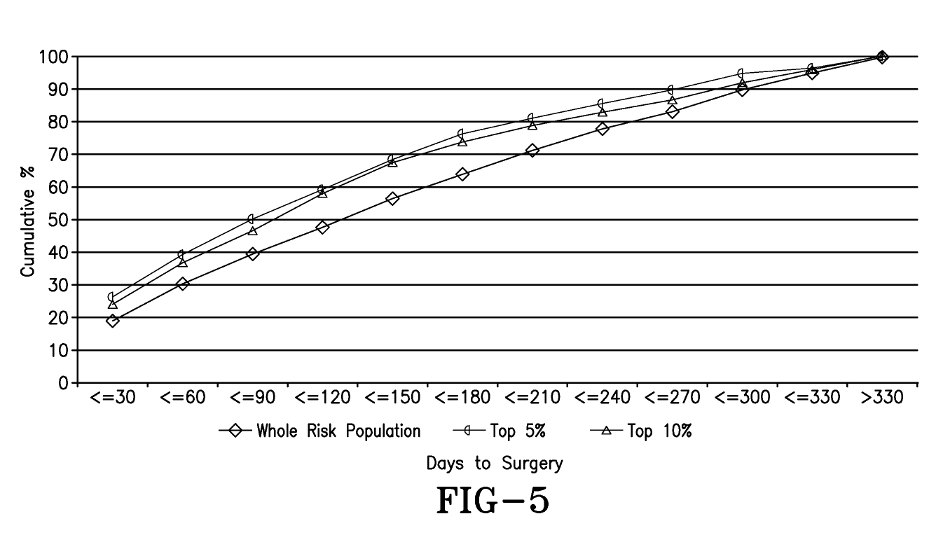

Referring to FIG. 5, a graph of actual days to surgery for a commercial population is shown. Actual days to surgery are shown for the commercial population that scored in the top 5% and top 10% groups. Corresponding numbers are shown in Table 4.

TABLE 4
Commercial Days to Surgery

| | % Expected to have back | |
|---|---|---|
| | surgeries within one year after | |
| Population | score date | Improvement Rate |
| Whole risk | 4.1% | |
| population | | |
| Top 5% | 19.96% | 4.87 |
| Top 10% | 16% | 3.90 |

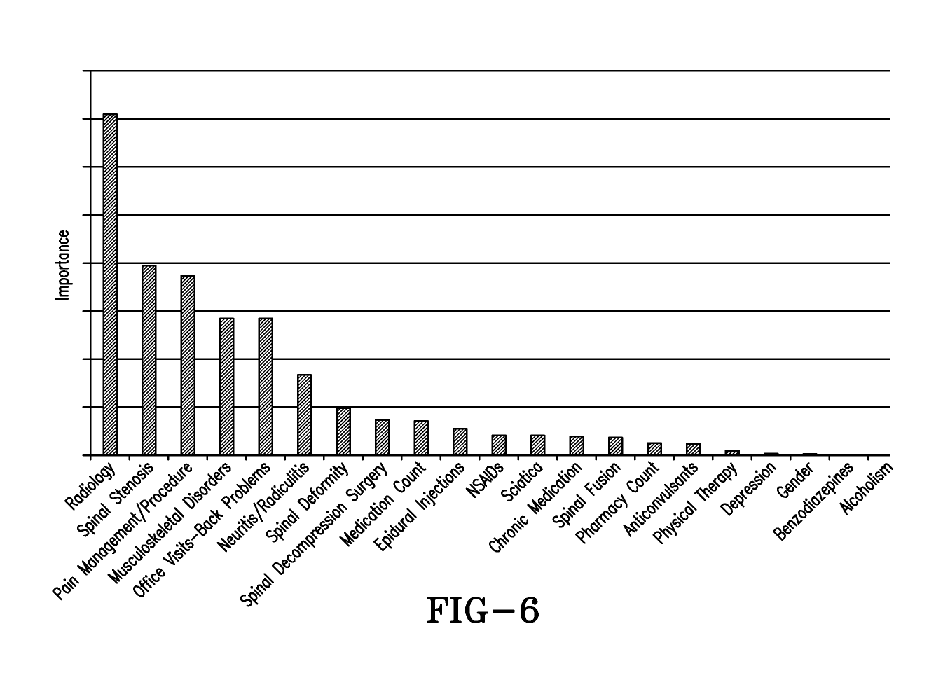

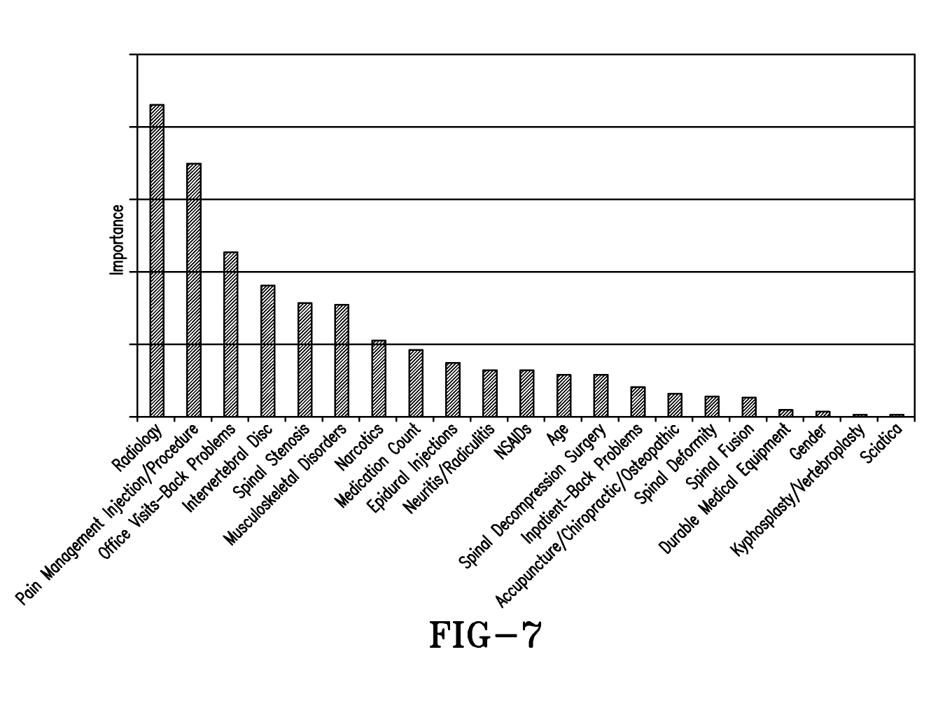

Referring to FIG. 6, an illustration of top predictors for a Medicare population according to an example embodiment is shown. Referring to FIG. 7, an illustration of top predictors for a commercial population according to an example embodiment is shown. As illustrated in FIGS. 6 and 7, the top predictors for the commercial and Medicare populations are similar (i.e., radiology, office visit for back problems, pain management treatments, certain medical conditions such as sciatica, stenosis, deformities, neuritis, radiculitis, intervertebral disc, and certain medications such as anesthetics, NSAIDS, and narcotics, and gender). In addition, age and osteopathic treatments provide predictive values for the commercial population while alcoholism has some predictive value for the Medicare population.

Tables 5-16 present quantitative data associated with top predictors for commercial and Medicare models according to an example embodiment.

TABLE 5
Top Predictors - Commercial

| | | Surgeries within | |
|---|---|---|---|
| Variable | Patients | one year | % |
| Age | | | |
| <=18 | 11,128 | 91 | 0.82 |
| >18 & <=30 | 18,594 | 341 | 1.83 |
| >30 & <=40 | 33,083 | 964 | 2.91 |
| >40 & <=50 | 48,348 | 1,838 | 3.80 |
| >50 & <=60 | 49,306 | 2,207 | 4.48 |
| >60 & <=70 | 17,872 | 901 | 5.04 |
| >70 & <=80 | 2,883 | 165 | 5.72 |
| >80 & <=90 | 962 | 48 | 4.99 |
| >90 | 88 | 0 | 0.00 |
| Gender | | | |
| F | 109,335 | 3,601 | 3.29 |
| M | 72,929 | 2,954 | 4.05 |

TABLE 6
Top Predictors - Medicare

| | | Surgeries within | |
|---|---|---|---|
| Variable | Patients | one year | % |
| Age | | | |
| <=18 | | | |
| >18 & <=30 | 325 | 9 | 2.77 |
| >30 & <=40 | 2,143 | 116 | 5.41 |
| >40 & <=50 | 9,286 | 525 | 5.65 |
| >50 & <=60 | 19,018 | 1,116 | 5.87 |
| >60 & <=70 | 52,315 | 2,796 | 5.34 |
| >70 & <=80 | 47,106 | 2,353 | 5.00 |
| >80 & <=90 | 19,890 | 757 | 3.81 |
| >90 | 1,881 | 36 | 1.91 |
| Gender | | | |
| F | 92,277 | 4,490 | 4.87 |
| M | 59,687 | 3,218 | 5.39 |

Men are more likely to have back surgeries. Age has a predictive value for the commercial population but not the Medicare population.

TABLE 7
Top Predictors - Commercial

| | | | |
|---|---|---|---|
| | | Surgeries within | |
| Variable | Patients | one year | % |

Physician Encounters
Office Visits

| | | | |
|---|---|---|---|
| 0 | 68,256 | 936 | 1.37 |
| 1 | 91,373 | 1,898 | 2.08 |
| >=2 | 143,400 | 8,873 | 6.19 |

Diagnostic
Radiology (XR/CT/MRI)

| | | | |
|---|---|---|---|
| 0 | 133,526 | 1,990 | 1.49 |
| 1 | 69,594 | 2,376 | 3.41 |
| >=2 | 99,909 | 7,341 | 7.35 |

TABLE 8
Top Predictors - Medicare

| | | | |
|---|---|---|---|
| | | Surgeries within | |
| Variable | Patients | one year | % |

Physician Encounters
Office Visits

| | | | |
|---|---|---|---|
| 0 | 49,729 | 1,355 | 2.72 |
| 1 | 59,539 | 2,192 | 3.68 |
| >=2 | 147,980 | 10,354 | 7.00 |

Diagnostic
Radiology (XR/CT/MRI)

| | | | |
|---|---|---|---|
| 0 | 95,689 | 2,486 | 2.60 |
| 1 | 54,583 | 2,614 | 4.79 |
| >=2 | 106,976 | 8,801 | 8.23 |

Patients that have more office visits related to a back condition are more like to proceed to surgery. Radiology visits are a stronger predictor.

TABLE 9
Top Predictors - Commercial

| Variable | | | |
|---|---|---|---|
| Pain Managements | | | |
| Injection & Procedures | Events | Surgeries within one year | % |
| 0 | 260,060 | 6,829 | 2.63 |
| 1 | 9,262 | 901 | 9.73 |
| >=2 | 33,707 | 3,977 | 11.80 |

TABLE 10
Top Predictors - Medicare

| | | | |
|---|---|---|---|
| Variable | Events | Surgeries within one year | % |

Treatments
Pain Managements Injection & Procedures

| | | |
|---|---|---|
| 197,400 | 8,013 | 4.06 |
| 15,566 | 1,392 | 8.94 |
| 44,282 | 4,496 | 10.15 |

Patients that have at least one pain management injection or procedure are much more likely to have back surgeries.

TABLE 11
Top Predictors Commercial

| | | | |
|---|---|---|---|
| Variable | Events | Surgeries within one year | % |

Alternative Treatments
Acupuncture/Chiropractic/Osteopathic

| | | | |
|---|---|---|---|
| 0 | 197,064 | 9,408 | 4.77 |
| >=1 | 105,965 | 2,299 | 2.17 |
| >=3 | 84,366 | 1,722 | 2.04 |

Acupuncture, chiropractic, and osteopathic treatments tend to prevent back surgeries in the commercial population.

TABLE 12
Top Predictors - Medicare

| | | | |
|---|---|---|---|
| Variable | Events | Surgeries within one year | % |

Behavior

| | | | |
|---|---|---|---|
| Alcoholism | | | |
| 0 claims | 254,624 | 13,730 | 5.39 |
| >=1 claims | 2,624 | 171 | 6.52 |

Alcoholism has some predictive value for the Medicare population.

TABLE 13
Top Predictors - Commercial

| | | | |
|---|---|---|---|
| Variable | Events | Surgeries within one year | % |

Medical Conditions

| | | | |
|---|---|---|---|
| Sciatica | | | |
| 0 claims | 270,268 | 9,475 | 3.51 |
| >=1 claims | 32,761 | 2,232 | 6.81 |

Stenosis

| | | | |
|---|---|---|---|
| 0 claims | 273,844 | 8,266 | 3.02 |
| >=1 claims | 29,185 | 3,441 | 11.79 |

Deformities

| | | | |
|---|---|---|---|
| 0 claims | 295,621 | 10,788 | 3.65 |
| >=1 claims | 7,408 | 919 | 12.41 |

Neuritis/Radiculitis

| | | | |
|---|---|---|---|
| 0 claims | 236,397 | 6,446 | 2.73 |
| >=1 claims | 66,632 | 5,261 | 7.90 |

Intervertebral Disc

| | | | |
|---|---|---|---|
| 0 claims | 171,080 | 2,582 | 1.51 |
| >=1 claims | 131,949 | 9,125 | 6.92 |

TABLE 14
Top Predictors - Medicare

| | | | |
|---|---|---|---|
| Variable | Events | Surgeries within one year | % |

Medical Conditions

| | | | |
|---|---|---|---|
| Sciatica | | | |
| 0 claims | 224,755 | 11,294 | 5.03 |
| >=1 claims | 32,493 | 2,607 | 8.02 |

Stenosis

| | | | |
|---|---|---|---|
| 0 claims | 192,461 | 7,098 | 3.69 |
| >=1 claims | 64,787 | 6,803 | 10.50 |

Deformities

| | | | |
|---|---|---|---|
| 0 claims | 244,390 | 12,304 | 5.03 |
| >=1 claims | 12,858 | 1,597 | 12.42 |

Neuritis/Radiculitis

| | | | |
|---|---|---|---|
| 0 claims | 180,716 | 7,277 | 4.03 |
| >=1 claims | 76,532 | 6,624 | 8.66 |

Certain medical conditions are good predictors for future back surgeries.

TABLE 15
Top Predictors - Commercial

| | | | |
|---|---|---|---|
| | | Surgeries within | |
| Variable | Events | one year | % |

Prescribed Medications
Anesthetics Injection

| | | | |
|---|---|---|---|
| 0 | 256,075 | 8,409 | 3.28 |
| 1 | 32,577 | 2,108 | 6.47 |
| >=2 | 14,377 | 1,190 | 8.28 |

NSAIDS

| | | | |
|---|---|---|---|
| 0 | 230,472 | 7,695 | 3.34 |
| 1 | 37,382 | 1,605 | 4.29 |
| >=2 | 35,175 | 2,407 | 6.84 |

Narcotics

| | | | |
|---|---|---|---|
| 0 | 198,089 | 5,465 | 2.76 |
| 1 | 32,881 | 1,134 | 3.45 |
| >=2 | 72,059 | 5,108 | 7.09 |

TABLE 16
Top Predictors - Medicare

| | | | |
|---|---|---|---|
| | | Surgeries within | |
| Variable | Events | one year | % |

Prescribed Medications
Anesthetics Injection

| | | | |
|---|---|---|---|
| 0 | 194,847 | 9,448 | 4.85 |
| 1 | 38,415 | 2,636 | 6.86 |
| >=2 | 23,986 | 1,817 | 7.58 |

NSAIDS

| | | | |
|---|---|---|---|
| 0 | 161,207 | 7,880 | 4.89 |
| 1 | 36,658 | 2,048 | 5.59 |
| >=2 | 59,383 | 3,973 | 6.69 |

Usage of these medications indicates that patients may have more severe back conditions and are more likely to undergo surgeries.

While certain embodiments of the present invention are described in detail above, the scope of the invention is not to be considered limited by such disclosure, and modifications are possible without departing from the spirit of the invention as evidenced by the claims. For example, the risk factors and predictors that are considered and aspects of member populations used for training may be varied and fall within the scope of the claimed invention. Various aspects of patient healthcare profiles may be varied and fall within the scope of the claimed invention. One skilled in the art would recognize that such modifications are possible without departing from the scope of the claimed invention.

1-9. (canceled)

10. A computerized system for predicting a risk of back surgery in a member population comprising:
(a) at least one computer storage device that:
(1) stores a plurality of back surgery predictors;
(2) stores a plurality of back surgery triggers; and
(b) at least one computing device in communication with said at least one computer storage device executing instructions to:
(1) receive member data for a member population, said member data comprising member claims data and member encounter data;
(2) receive non-member data comprising consumer, demographic, and geographic data;
(3) identify a plurality of members in said member population having at least one of said plurality of back surgery triggers;
(4) for each of said plurality of members:
(i) create a member portrait according to said member's data and non-member data relevant to said member; and
(ii) apply to said member portrait a predictive model to identify one or more back surgery predictors for said member; and
(iii) calculate for said member a back surgery risk score according to said back surgery predictors in said member portrait.

11. The computerized system of claim 10 wherein the step to identify a plurality of members in said member population having at least one of said plurality of back surgery triggers is executed monthly.

12. The computerized system of claim 10 wherein said back surgery risk score indicates a likelihood of a surgery selected from the group consisting of:
spinal fusion, kyphosplasty, vertebroplasty, and decompression surgery.

13. The computerized system of claim 10 wherein said back surgery risk score indicates a likelihood of a back surgery in the next 12 months.

14. The computerized system of claim 10 wherein said member population is selected from the group consisting of:
governmental, commercial, fully-insured, and administrative services only member populations.

15. The computerized system of claim 10 wherein said back surgery predictors are selected from the group consisting of:
radiology, spinal stenosis, pain management injection or procedure, musculoskeletal disorders, back problem office visits, neuritis or radiculitis, spinal deformity, spinal decompression surgery, medication count, epidural injections, non-steroidal anti-inflammatory drugs, sciatica, chronic medication, spinal fusion, pharmacy count, anticonvulsants, physical therapy, depression, gender, benzodiazepines, and alcoholism.

16. The computerized system of claim 10 wherein said back surgery predictors are selected from the group consisting of:
radiology, spinal stenosis, pain management injection or procedure, back problem office visits, intervertebral disc, spinal stenosis, musculoskeletal disorders, narcotics, medication count, epidural injections, neuritis or radiculitis, non-steroidal anti-inflammatory drugs, age, spinal decompression surgery, back problem inpatient procedures, acupuncture, chiropractic, or osteopathic procedures, spinal deformity, spinal fusion, durable medical equipment purchases, gender, kyphosplasty or vertebroplasty, and sciatica.

17. The computerized system of claim 10 wherein said back surgery predictive model is trained with training samples extracted and scored a plurality of times during a one year period to identify risk factors are related to seasonality.

18. The computerized system of claim 10 wherein said back surgery predictive model is trained with training samples extracted and scored a plurality of times during a one year period to identify pathological stage and pathological level of severity risk factors.

19. A computerized method for predicting a risk of back surgery in a member population comprising one or more computing devices executing instructions for:
(1) storing a plurality of back surgery predictors;
(2) storing a plurality of back surgery triggers; and
(3) executing instructions to:
(a) receive member data for a member population, said member data comprising member claims data and member encounter data;
(b) receive non-member data comprising consumer, demographic, and geographic data;
(c) identify a plurality of members in said member population having at least one of said plurality of back surgery triggers;
(d) for each of said plurality of members:
(i) create a member portrait according to said member's data and non-member data relevant to said member; and
(ii) apply to said member portrait a back surgery predictive model to identify one or more back surgery predictors for said member, said predictive model trained with training samples extracted and scored a plurality of times during a specified period to identify risk factors are related to seasonality; and
(iii) calculate for said member a back surgery risk score according to said back surgery predictors in said member portrait.

20. The computerized method of claim 19 wherein said specified period of time is one year.
